(19) United States
(12) Patent Application Publication
(10) Pub. No.: US 2026/0182580 A1
(43) Pub. Date: Jul. 2, 2026

(54) ANTIMICROBIAL COATING COMPOSITION AND METHOD OF PRODUCING ANTIMICROBIAL PRODUCT USING THE SAME

(71) Applicants: TWINWIZ INC., Changwon-si, Gyeongsangnam-do (KR); KOREA INSTITUTE OF MATERIALS SCIENCE, Changwon-si, Gyeongsangnam-do (KR)

(72) Inventors: Chang Su KIM, Changwon-si, Gyeongsangnam-do (KR); Han Soo SHIM, Changwon-si, Gyeongsangnam-do (KR); Ga Hyun LEE, Changwon-si, Gyeongsangnam-do (KR); Chang Seok HEO, Changwon-si, Gyeongsangnam-do (KR); Min Hyeok UM, Changwon-si, Gyeongsangnam-do (KR); Yu Jin KIM, Changwon-si, Gyeongsangnam-do (KR); Min Seok LEE, Changwon-si, Gyeongsangnam-do (KR); Hee Lyeon CHOI, Changwon-si, Gyeongsangnam-do (KR)

(21) Appl. No.: 18/574,742

(22) PCT Filed: Nov. 30, 2023
(86) PCT No.: PCT/KR2023/019625

§ 371 Date: Feb. 1, 2024

(30) Foreign Application Priority Data
Nov. 30, 2023 (KR) 10-2023-0170864

(51) Int. Cl. A01N 59/16; A01N 25/10; A01P 1/00; C09D 5/14; C09D 7/61; C09D 175/00

(52) U.S. Cl. CPC A01N 59/16; A01N 25/10; A01P 1/00; C09D 5/14; C09D 7/61; C09D 175/00

(57) ABSTRACT

The present inventive concept relates to an antimicrobial coating composition, and more specifically, to an antimicrobial coating composition whose components have excellent solubility in the composition and which may be prevented from discoloring, and at the same time, exhibits excellent antimicrobial effects, and a method of producing an antimicrobial product using the same.

### TECHNICAL FIELD

The present inventive concept relates to an antimicrobial coating composition, and more specifically, to an antimicrobial coating composition whose components have excellent solubility in the composition and which may be prevented from discoloring, and at the same time, exhibits excellent antimicrobial effects, and a method of producing an antimicrobial product using the same.

### BACKGROUND ART

Recently, as interest in hygiene and in prevention of infections caused by various bacteria, fungi and viruses has increased, preference for products with antimicrobial properties has also increased for products that we come into direct contact with in our daily lives.

In this regard, antimicrobial functions are also required for various IT devices such as smartphones, laptops, and monitors, which frequently come into direct contact with the human body. Accordingly, the development of products with antimicrobial properties, such as resins for application to IT devices or film products produced therefrom, is accelerating.

However, in order to impart antimicrobial function to products for application to IT devices, etc., it is very important that the optical properties and mechanical properties of the final produced resin film do not deteriorate even if an antimicrobial material is added to the resin.

Inorganic antimicrobial such as silver nanoparticles, zeolite, calcium phosphate, zirconium phosphate, and silica gel, which are commonly used as antimicrobial materials, have difficulty in maintaining their physical properties, including optical and mechanical properties, when applied to the various products mentioned above. Furthermore, due to an issue regarding the harmfulness of antimicrobial materials to the human body, their safety has also emerged as an important factor.

In addition, in the case of conventional antimicrobial resin compositions, there are problems in that the components of the composition have poor solubility in the composition, or even if the solubility thereof is excellent, the composition cannot be prevented from discoloring, or has poor antimicrobial properties.

Accordingly, there is an urgent need to develop an antimicrobial composition whose components have excellent solubility in the composition and which may be prevented from discoloring and, at the same time, exhibits excellent antimicrobial effects.

### DISCLOSURE

### Technical Problem

An object of the present inventive concept is to provide an antimicrobial composition whose components have excellent solubility in the composition and which may be prevented from discoloring and, at the same time, exhibits excellent antimicrobial effects, and a method of producing an antimicrobial product using the same.

Another object of the present inventive concept is to provide an antimicrobial coating composition that may have a minimized impact on the physical properties of products such as antimicrobial films, to which it is applied.

Still another object of the present inventive concept is to provide an antimicrobial coating composition that not only has excellent antimicrobial activity but also exhibits excellent effects in terms of one or more of transmittance, turbidity, chromaticity, hardness, and adhesion, and a method of producing an antimicrobial product using the same.

Other objects and advantages of the present inventive concept will become more apparent from the following detailed description, the appended claims, and the accompanying drawings.

### Technical Solution

To achieve the above objects, the present inventive concept provides an antimicrobial coating composition comprising: an antimicrobial agent containing silver; a coating material containing a viscosity modifier; and an additive.

According to one embodiment of the present inventive concept, the antimicrobial agent may comprise a solvent and a silver salt.

In addition, the coating material may comprise a hexafunctional urethane acrylate-based oligomer.

In addition, the viscosity modifier may be at least one selected from the group consisting of 1,6-hexanediol diacrylate (HDDA), dipropylene glycol diacrylate (DPGDA), dipentaerythritol pentaacrylate (DPPA), dipentaerythritol hexaacrylate (DPHA), isobornyl acrylate (IBOA), tripropylene glycol diacrylate (TPGDA), pentaerythritol triacrylate (PETA), pentaerythritol tetraacrylate (PETTA), and trimethylolpropane triacrylate (TMPTA).

In addition, the additive may comprise any one or more selected from the group consisting of an antioxidant, an UV absorber, a light stabilizer, and a pH adjuster.

In addition, the additive may be at least one of a phenylformamidine-based UV absorber, a phenol-based antioxidant, and a phosphite-based antioxidant.

In addition, the antimicrobial agent, the coating material and the additive may be comprised in amounts of 0.5 to 1.5 wt %, 97 to 99 wt %, and 0.5 to 1.5 wt %, respectively.

In addition, the composition may have an antimicrobial activity of 99.9% or more as evaluated according to the following Experimental Method 1:

### Experimental Method 1

Apply the antimicrobial coating composition to a PET film to an average thickness of 5 μm using a bar coater, prebake the applied composition at a temperature of 75° C., cure the prebaked composition with UV light to obtain a film-shaped specimen, and then measure the antimicrobial activity of the specimen against E. coli according to the JIS Z 2801 method.

In addition, the composition may have a haze of 3% or less and a color change (ΔE*) of 5 or less, as evaluated according to the following Experimental Method 2:

### Experimental Method 2

Measure the haze and color change of the antimicrobial coating composition using a spectrophotometer according to JIS K 7105.

The present inventive concept also provides a method for producing an antimicrobial product comprising: a first step of preparing an antimicrobial agent by adding an antimicrobial agent containing silver to a solvent; a second step of preparing an antimicrobial coating composition by mixing the antimicrobial agent with a coating material, which contains a viscosity modifier, and an additive; and a third step of coating a product with the antimicrobial coating composition.

### Advantageous Effects

According to one embodiment of the present inventive concept, the antimicrobial coating composition and the method of producing an antimicrobial product using the same according to the present inventive concept are effective in that the components of the composition have excellent solubility and the composition may be prevented from discoloring and, at the same time, has excellent antimicrobial properties.

According to one embodiment of the present inventive concept, the antimicrobial coating composition according to the present inventive concept may not only have a minimized impact on the physical properties of products such as antimicrobial films, to which it is applied, but also impart high antimicrobial activity and allow high optical properties and/or mechanical properties to be maintained.

According to one embodiment of the present inventive concept, the antimicrobial coating composition and the method of producing an antimicrobial product according to the present inventive concept make it possible to produce an antimicrobial product, which has excellent antimicrobial activity and is excellent in terms of one or more of transmittance, turbidity, chromaticity, hardness, and adhesion, in a cost-effective and efficient manner.

### BRIEF DESCRIPTION OF DRAWINGS

FIG. 1 schematically shows a method of producing an antimicrobial product by coating with an antimicrobial coating composition according to one embodiment of the present inventive concept.

FIG. 2 depicts photographs showing the results of evaluating whether discoloration of an antimicrobial coating composition according to one embodiment of the present inventive concept occurred.

FIG. 3 depicts photographs the results of evaluating whether discoloration of an antimicrobial coating composition according to one embodiment of the present inventive concept occurred and the antimicrobial activity of the composition.

FIG. 4 depicts photographs showing the results of evaluating whether discoloration of an antimicrobial coating composition according to one embodiment of the present inventive concept occurred.

FIG. 5 depicts photographs showing the results of evaluating whether discoloration of an antimicrobial coating composition according to one embodiment of the present inventive concept occurred.

FIG. 6 depicts photographs showing the results of evaluating whether discoloration of an antimicrobial coating composition according to one embodiment of the present inventive concept occurred.

FIG. 7 depicts photographs the results of evaluating whether discoloration of an antimicrobial coating composition according to one embodiment of the present inventive concept occurred and the antimicrobial activity of the composition.

FIG. 8 depicts photographs showing the results of evaluating the solubility of components of an antimicrobial coating composition according to one embodiment of the present inventive concept and whether discoloration of the composition occurred.

FIG. 9 depicts photographs showing the results of evaluating the solubility of components of an antimicrobial coating composition according to one embodiment of the present inventive concept.

FIG. 10 depicts photographs the results of evaluating whether discoloration of an antimicrobial coating composition according to one embodiment of the present inventive concept occurred and the antimicrobial activity of the composition.

### BEST MODE

The objects, specific advantages, and novel features of the present disclosure will become more apparent from the following detailed description and embodiments taken in conjunction with the accompanying drawings.

The terms and words used in the specification and claims should not be interpreted as being limited to typical meanings or dictionary definitions, but should be interpreted as having meanings and concepts relevant to the technical spirit of the present disclosure, based on the principle that the inventors can appropriately define the meaning of the terms to describe their inventive concept in the best manner.

In the present specification, when a component such as a layer, a portion, or a substrate is referred to as being “on”, “connected to”, or “coupled to” another component, it may be directly “on”, “connected to”, or “coupled to” the other component, and there may also be one or more other intervening components between the two components. In contrast, when a component is referred to as being “directly on”, “directly connected to”, or “directly coupled to” another component, there may not be other intervening components between the two components.

The terms used in this specification are merely used to describe specific embodiments and are not intended to limit the present disclosure. Singular expressions include plural expressions unless the context clearly dictates otherwise.

In the present specification, it should be understood that terms such as “comprise”, “contain”, and “have” are intended to denote the existence of mentioned characteristics, numbers, steps, operations, components, parts, or combinations thereof, but do not exclude the probability of existence or addition of one or more other characteristics, numbers, steps, operations, components, parts, or combinations thereof.

In the present specification, it is to be understood that when any part is referred to as “comprising” any component, it does not exclude other components, but may further comprise other components, unless otherwise specified. In addition, throughout the specification, “being on” means locating above or below the target part, and does not necessarily mean locating above with respect to the direction of gravity.

Since the present disclosure may be subjected to various modifications, and may have various embodiments, specific embodiments are illustrated in the drawings and will be described in the detailed description. However, this is not intended to limit the present disclosure to specific embodiments. It should be understood that the present disclosure includes all modifications, equivalents or replacements that fall within the spirit and technical scope of the present disclosure. In the following description, the detailed description of related publicly-known technology will be omitted when it may unnecessarily obscure the subject matter of the present disclosure.

Hereinafter, embodiments of the present disclosure will be described in detail with reference to the accompanying drawings. In the description with reference to the accompanying drawings, identical or corresponding components will be assigned the same reference numerals and redundant description thereof will be omitted.

According to one aspect, an antimicrobial composition of the present inventive concept comprises: an antimicrobial agent containing silver (Ag); a coating material containing a viscosity modifier; and an additive.

Hereinafter, each component comprised in the antimicrobial coating composition of the present inventive concept will be described.

First, the antimicrobial agent containing silver will be described.

The antimicrobial agent may contain a solvent and a silver salt. Preferably, it may contain, as the silver salt, silver perchlorate, and in this case, the purpose of the present inventive concept may be more advantageously achieved.

The antimicrobial agent overcomes problems with existing antimicrobial agents, including low long-term storage stability and heat resistance, has excellent long-term storage stability and heat resistance, exhibits excellent antimicrobial activity even when used in small quantities, and may have a minimized impact on the physical properties of products such as antimicrobial films, to which it is applied. In addition, the antimicrobial agent is safe because it does not contain safety-related restricted substances such as zeolite and quaternary ammonium salts.

The antimicrobial agent may form no precipitate even after being stored at room temperature for 2 weeks or more, without being limited thereto. Conventional antimicrobial agents have a problem in that they form brown precipitates after 2 weeks of storage at room temperature, indicating that the antimicrobial agents have low long-term storage stability and are not easy to store and/or manage. However, the antimicrobial agent of the present inventive concept forms no precipitate even when stored at room temperature for 2 weeks or more, 3 weeks or more, 4 weeks or more, or even 3 months or more, and thus may have excellent long-term storage stability and long-term durability.

The antimicrobial agent may be characterized in that it does not discolor even after being stored for 5 minutes or more at a temperature of 150° C. or higher, without being limited thereto. Conventional antimicrobial agents begin to discolor after being stored at a temperature of 150° C. or higher for 10 minutes or more, or at a temperature of 200° C. or higher for 10 minutes or more, or at a temperature of 250° C. or higher for 5 minutes or more, and thus have low heat resistance. Thus, in the case of conventional antimicrobial agents, problems such as discoloration may occur when an antimicrobial coating composition that requires high-temperature treatment is prepared and/or when an antimicrobial coating is formed on a product. However, the antimicrobial agent of the present inventive concept may have excellent heat resistance because no discoloration or precipitation is observed even when the antimicrobial agent is stored for 5 minutes or more or 10 minutes or more at 150° C. or higher, 200° C. or higher, or even 250° C. or higher.

The silver salt may be contained in an amount of 0.15 parts by weight or more based on the total weight of the antimicrobial agent, without being limited thereto. When the silver salt is contained in an amount of 0.15 parts by weight or more based on the total weight of the antimicrobial agent, it may be suitable for improving antimicrobial activity and, at the same time, dramatically improving long-term storage stability and heat resistance and minimizing its impact on the physical properties of a product to which it is applied, without being limited thereto. Preferably, the silver salt may be contained in an amount of 0.15 to 5 parts by weight, more preferably 0.2 to 3 parts by weight, even more preferably 0.2 to 2 parts by weight. Still more preferably, the silver salt may be contained in an amount of 0.3 to 1 part by weight in terms of antimicrobial activity. If the silver salt is contained in an amount of less than 0.15 parts by weight based on the total weight of the antimicrobial agent, the antimicrobial activity of the antimicrobial agent may be significantly reduced, and if the silver salt is contained in an amount of more than 5 parts by weight, the physical properties (especially turbidity) of a product to which the antimicrobial agent is applied may be significantly reduced, without being limited thereto.

The solvent is contained in an amount of 95 to 99.75 parts by weight based on the total weight of the antimicrobial agent, without being limited thereto. This content of the solvent may be suitable for improving the antimicrobial activity of a product to which the antimicrobial agent is applied, and at the same time, improving the solubility of components of the composition, preventing discoloration of the composition, and minimizing the impact of the composition on the physical properties of a product to which the composition it is applied.

The solvent may be at least one of alcohol and water, but is not limited thereto and may be appropriately selected and used depending on the type of product requiring antimicrobial properties, to which the antimicrobial coating composition is applied.

The solvent may be at least one selected from among ethanol, isopropyl alcohol, propylene glycol monomethyl ether acetate, methyl isobutyl ketone, DI water, ethylene glycol, acetone, 1-propanol, propylene glycol, propylene glycol methyl ether, methyl ethyl ketone, diethyl ether, dichloromethane, N,N-dimethylformamide, toluene, acetylene, and ethylene dichloride, without being limited thereto. In this case, the solvent may be suitable for improving the antimicrobial activity of a product to which the antimicrobial coating composition is applied, and at the same time, improving long-term storage stability and heat resistance, improving the solubility of components of the composition, and minimizing the impact of the composition on the physical properties of a product to which the composition is applied. At least one selected from among ethanol and isopropyl alcohol may be more preferred, and ethanol may be even more preferred.

Now, the coating material containing a viscosity modifier will be described.

The viscosity modifier functions to control the viscosity of the antimicrobial coating composition, enabling a uniform coating to be formed when the composition is applied to a product, and improve the dispersion of components in the composition, thereby improving the uniformity of physical properties of the coating layer.

As the viscosity modifier, any viscosity modifier commonly used in the art may be used without limitation. Preferably, the viscosity modifier may comprise at least one selected from the group consisting of 1,6-hexanediol diacrylate (HDDA), dipropylene glycol diacrylate (DPGDA), dipentaerythritol pentaacrylate (DPPA), dipentaerythritol hexaacrylate (DPHA), isobornyl acrylate (IBOA), tripropylene glycol diacrylate (TPGDA), pentaerythritol triacrylate (PETA), pentaerythritol tetraacrylate (PETTA), and trimethylolpropane triacrylate (TMPTA). More preferably, the viscosity modifier may comprise any one or more of dipentaerythritol pentaacrylate (DPPA) and dipentaerythritol hexaacrylate (DPHA), and in this case, the purpose of the present inventive concept may be more advantageously achieved.

Meanwhile, according to one embodiment of the present inventive concept, the coating material may further comprise an acrylate-based oligomer.

As the acrylate-based oligomer, a known acrylate-based oligomer may be used without limitation as long as it does not reduce the solubility of the components of the composition, does not cause discoloration of the composition, and does not reduce the antimicrobial properties of the composition. Preferably, the acrylate-based oligomer may comprise any one or more of an aliphatic hexafunctional acrylate monomer, an aromatic difunctional acrylate monomer, an aliphatic multi-functional acrylate monomer, an aliphatic difunctional diacrylate monomer, an aliphatic difunctional acrylate monomer, an aliphatic difunctional methacrylate monomer, an aliphatic trifunctional acrylate monomer, an aliphatic trifunctional methacrylate monomer, an aromatic trifunctional acrylate monomer, an aromatic trifunctional methacrylate monomer, an aliphatic tetrafunctional acrylate monomer, an aliphatic hexafunctional acrylate monomer, and an aliphatic tetrafunctional methacrylate monomer. More preferably, the acrylate-based oligomer may comprise a hexafunctional urethane acrylate-based oligomer. This acrylate-based oligomer may be more advantageous in that it has good coating properties and adhesion when determining the suitability of the antimicrobial agent, can have a minimized effect on changes in the physical properties of the composition without adversely affecting the optical properties, does not reduce the solubility of the components of the composition, does not cause discoloration of the composition, and does not reduce the antimicrobial properties of the composition.

In this case, the coating material may comprise the acrylate-based oligomer and the viscosity modifier at a weight ratio of 1:0.1 to 0.6, preferably 1:0.15 to 0.55. If the weight ratio of the acrylate-based oligomer to the viscosity modifier is less than 1:0.1, it is impossible to form a uniform coating when applying the composition to a product, or the dispersion of the compositions in the composition may be poor, which may reduce the uniformity of physical properties of the coating layer, and if the weight ratio is more than 1:0.6, the antimicrobial properties of the composition may be relatively reduced.

Now, the additive will be described.

The additive functions to prevent discoloration of the antimicrobial coating composition according to the present inventive concept without reducing the antimicrobial properties of the antimicrobial coating composition and the solubility of the components of the composition.

As the additive, any additive may be used without limitation as long as it is commonly used in the art. Preferably, the additive may comprise any one or more selected from the group consisting of an antioxidant, an UV absorber, a light stabilizer, and a pH adjuster. More preferably, the additive may comprise any one or more of an antioxidant and an UV absorber. Most preferably, the additive may comprise an antioxidant and an UV absorber.

In this case, as the antioxidant, any antioxidant may be used without limitation as long as it can prevent discoloration of the antimicrobial coating composition according to the present inventive concept without reducing the antimicrobial properties of the antimicrobial coating composition and the solubility of the components of the composition. Preferably, the antioxidant may comprise any one or more of a phenol-based antioxidant, an amine-based antioxidant, and a phosphite-based antioxidant. More preferably, the antioxidant comprises a phenol-based antioxidant. This antioxidant may be more advantageous in terms of preventing discoloration of the antimicrobial coating composition without reducing the antimicrobial properties of the composition and the solubility of the components of the composition.

In addition, in this case, as the UV absorber, any UV absorber may be used without limitation as long as it can prevent discoloration of the antimicrobial coating composition according to the present inventive concept without reducing the antimicrobial properties of the composition and the solubility of the components of the composition. Preferably, the UV absorber may comprise any one or more of a triazine-based UV absorber, a benzophenone-based UV absorber, a benzoate-based UV absorber, a benzotriazole-based UV absorber, and a phenylformamidine-based UV absorber. More preferably, the UV absorber may comprise a phenylformamidine-based UV absorber, and this UV absorber may be more advantageous in terms of preventing discoloration of the antimicrobial coating composition without reducing the antimicrobial properties of the composition and the solubility of the components of the composition.

In addition, in this case, as the antioxidant, any antioxidant may be used without limitation as long as it can prevent discoloration of the antimicrobial coating composition according to the present inventive concept without reducing the antimicrobial properties of the composition and the solubility of the components of the composition. Preferably, the antioxidant may comprise a phosphite-based antioxidant. This antioxidant may be more advantageous in terms of preventing discoloration of the antimicrobial coating composition without reducing the antimicrobial properties of the composition and the solubility of the components of the composition.

Meanwhile, preferably, the additive may comprise the antioxidant, and most preferably, it may comprise a phosphite-based antioxidant.

Meanwhile, the antimicrobial coating composition according to the present inventive concept may comprise the antimicrobial agent, the coating material and the additive in amounts of 0.5 to 1.5 wt %, 97 to 99 wt %, and 0.5 to 1.5 wt %, respectively, and preferably 0.7 to 1.3 wt %, 97.4 to 98.6 wt %, and 0.7 to 1.3 wt %, respectively. If the antimicrobial agent is comprised in an amount of less than 0.5 wt %, the antimicrobial properties of the composition may be reduced, and if the antimicrobial agent is comprised in an amount of more than 1.5 wt %, it may cause discoloration of the composition and reduce physical properties in the case of transparent films that require optical properties such as light transmittance. In addition, if the coating material is comprised in an amount of less than 97 wt %, physical properties may be reduced in the case of transparent films that require optical properties such as light transmittance, and if the coating material is comprised in an amount of more than 99 wt %, it may cause discoloration of the composition and reduce the antimicrobial properties of the composition. In addition, if the additive is comprised in an amount of less than 0.5 wt %, discoloration of the composition may occur, and if the additive is comprised in an amount of more than 1.5 wt %, the antimicrobial properties of the composition may be relatively reduced.

Meanwhile, the antimicrobial coating composition according to the present inventive concept may have an antimicrobial activity of 99.9% or more, preferably 99.95% or more, as evaluated according to the following Experimental Method 1:

### Experimental Method 1

Apply the antimicrobial coating composition to a PET film to an average thickness of 5 μm using a bar coater, prebake the applied composition at a temperature of 75° C., cure the prebaked composition with UV light to obtain a film-shaped specimen, and then measure the antimicrobial activity of the specimen against E. coli according to the JIS Z 2801 method.

Accordingly, the solubility of the components of the composition is excellent, discoloration of the composition may be prevented, and at the same time, the composition may exhibit excellent antimicrobial properties.

In addition, the antimicrobial coating composition according to the present inventive concept may have a haze of 3% or less and a color change (ΔE*) of 5 or less, as evaluated according to Experimental Method 2 below. Preferably, the antimicrobial coating composition may have a haze of 2% or less and a color change (ΔE*) of 4 or less. More preferably, the antimicrobial coating composition may have a haze of 1% or less and a color change (ΔE*) of 3.5 or less. Even more preferably, the antimicrobial coating composition may have a haze of 0.5% or less and a color change (ΔE*) of 3.1 or less.

### Experimental Method 2

Measure the haze and color change of the antimicrobial coating composition using a spectrophotometer according to JIS K 7105.

Accordingly, the solubility of the components of the composition is excellent, discoloration of the composition may be prevented, and at the same time, the composition may exhibit excellent antimicrobial properties.

The antimicrobial coating composition of the present inventive concept may be used to coat various products. The antimicrobial coating composition provided as described above may impart maximum antimicrobial activity to surfaces that are in contact with the human body, may have a minimized impact on the physical properties of a product to which it is applied, and at the same time, can minimize the production cost.

The antimicrobial coating composition of the present application may be used to coat transparent films, without being limited thereto. As described above, the antimicrobial coating composition of the present inventive concept, when applied to a product surface, can dramatically improve the antimicrobial activity of the product surface, and at the same time, the solubility of the components of the composition may be excellent and discoloration of the composition may be prevented. Therefore, the composition may have a minimized impact on the optical properties (such as light transmittance and/or turbidity) of a product to which it is applied. Thus, the composition may be particularly suitable for transparent films where optical properties such as light transmittance and turbidity are very important, especially transparent films for application to IT devices.

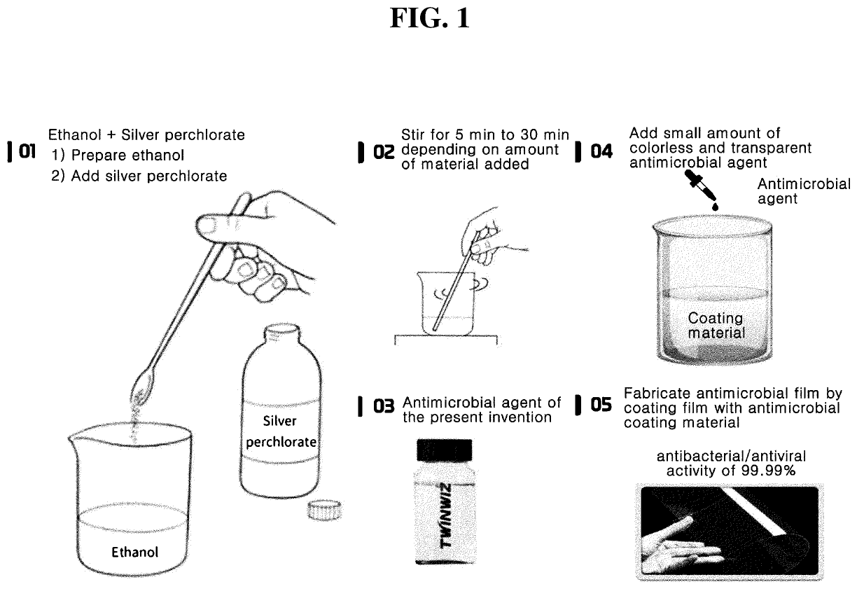

FIG. 1 schematically shows a method of producing an antimicrobial product by coating with an antimicrobial coating composition according to one embodiment of the present inventive concept.

Meanwhile, the present inventive concept provides a method for producing an antimicrobial product comprising: a first step of preparing an antimicrobial agent by adding an antimicrobial agent containing silver to a solvent; a second step of preparing an antimicrobial coating composition by mixing the antimicrobial agent with a coating material containing a viscosity modifier, and an additive; and a third step of coating a product with the antimicrobial coating composition.

In the following description of the production method for the antimicrobial product, the same contents as those described with respect to the antimicrobial coating composition will be omitted.

First, the first step of manufacturing an antimicrobial agent will be described.

The antimicrobial agent may be prepared by adding an antimicrobial agent containing silver to a solvent. In this case, the antimicrobial agent may be prepared by stirring for a predetermined time. The stirring time may be 1 hour or less, 30 seconds to 30 minutes, 30 seconds to 20 minutes, 30 seconds to 10 minutes, 30 seconds to 5 minutes, or 30 seconds to 3 minutes.

When the antimicrobial agent containing silver contains silver perchlorate as a silver salt, the silver perchlorate is dissolved in most solvents within 1 minute, and thus, the solubility of the silver salt in the preparation of the antimicrobial agent according to the present inventive concept may be maximized, minimizing the stirring time, which leads to a dramatic increase in productivity. Accordingly, the present inventive concept includes, but does not exclude, preparing an antimicrobial agent by adding and dissolving a silver salt in a solvent without stirring.

Now, the second step of preparing an antimicrobial coating composition will be described.

As described above, to produce the antimicrobial product according to the present inventive concept and the antimicrobial coating composition with which the product is coated, the antimicrobial agent is first prepared and then mixed with the coating material and the additive. If the components of the antimicrobial agent are directly mixed with the coating material and the additive, the dispersibility thereof may be significantly reduced, and thus a product to which the composition is applied may not exhibit uniform physical properties, or the physical properties may deteriorate.

Now, the third step of coating a product with the antimicrobial coating composition will be described.

The coating method may be performed using various known coating methods such as spin coating. For coating, the composition may be applied to a product to a thickness of 2 μm or more, preferably 4 μm or more, without being limited thereto. This coating thickness may be suitable for improving the antimicrobial activity of the product to which the composition is applied, while minimizing the impact of the composition on the physical properties of the product. However, the coating thickness may be selected depending on the intended use, because curls may appear depending on the type of substrate being coated with the composition.

The product to which the composition is applied may be a transparent film, without being limited thereto. As described above, the antimicrobial coating composition of the present inventive concept, when applied to a product surface, can dramatically improve the antimicrobial activity of the product surface, and at the same time, the impact thereof on the optical properties (such as light transmittance and/or turbidity) of the product is minimized. Therefore, the antimicrobial coating composition may be particularly suitable for transparent films where optical properties such as light transmittance and turbidity are very important, especially transparent films for application to IT devices.

The present inventive concept will be described in more detail by way of the following examples. However, the following examples do not limit the scope of the present inventive concept, and should be construed to aid understanding of the present inventive concept.

### MODE FOR INVENTIVE CONCEPT

### EXAMPLES

### Example 1 -1 to Example 1-8: Antioxidant as Additive

An antimicrobial agent was prepared by adding 0.3 parts by weight of silver perchlorate as a silver salt to ethanol as a solvent at a concentration of 1 wt %, followed by stirring for 10 minutes. Then, antimicrobial coating compositions were prepared by mixing 98 wt % of a coating material, comprising a hexafunctional urethane acrylate-based oligomer as an acrylate-based monomer and dipentaerythritol pentaacrylate (DPPA) as a viscosity modifier at a weight ratio of 1:0.35, with 1 wt % of the prepared antimicrobial agent, and 1 wt % of each of the following antioxidants as an additive: benzenepropanoic acid, 3,5-bis(1,1-dimethylethyl)-4-hydroxy-,C7-9 branched alkyl ester (primary phenol-based) (Example 1-1), triethylene glycol-bis-3-(3-tert-butyl-4-hydroxy-5-methylphenyl) propionate (primary phenol-based) (Example 1-2), octadecyl-3-(3,5-di-tert-butyl-4-hydroxyphenyl)propionate (primary phenol-based) (Example 1-3), 1,3,5-trimethyl-2,4,6-tris(3,5-di-tert-butyl-4-hydroxybenzyl) benzene (primary phenol-based) (Example 1-4), isooctyl-3-(3,5-di-tert-butyl-4-hydroxyphenyl)propionate (primary phenol-based) (Example 1-5), tris(3,5-di-tert-butyl-4-hydroxybenzyl)isocyanurate (primary phenol-based) (Example 1-6), a mixture of butylated & octylated diphenylamine (primary amine-based) (Example 1-7), and tris(2,4-di-tert-butylphenyl) phosphite (secondary phosphite-based) (Example 1-8).

### Experimental Example 1

For the antimicrobial coating compositions according to Example 1 -1 to Example 1-8, the following items were evaluated and the results are shown in FIG. 1.

### 1. Discoloration Evaluation

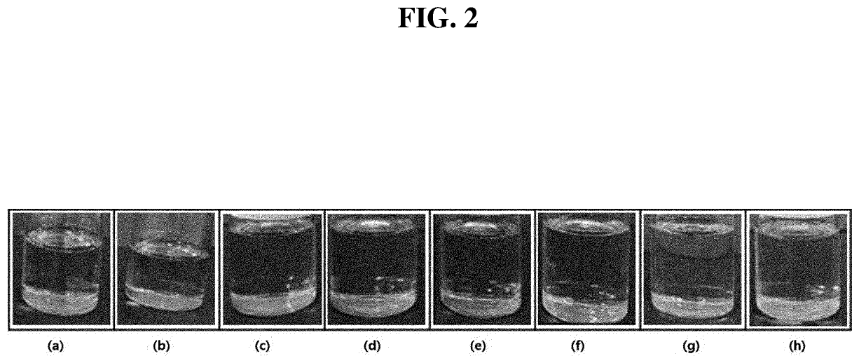

The antimicrobial coating compositions according to Examples 1 -1 to 1-8 were visually evaluated as to whether discoloration occurred 1 day after addition of the additive (FIGS. 2a to 2h: photographs of the compositions of Example 1 -1 to Example 1-8, respectively, 1 day after addition of the additive).

As can be seen in FIG. 2, it can be confirmed that discoloration occurred in the compositions of Examples 1 -1 to 1-8 according to the present inventive concept.

### 2. Evaluation of Haze and Color Change

For the antimicrobial coating composition according to Example 1-1, the haze and color change were measured using a spectrophotometer according to JIS K 7105.

As a result, it was confirmed that the composition showed haze: 3.12%, a*: 0.93, b*: 12.62, and ΔE*: 12.58, indicating that the haze of the composition was high and the color change thereof was high.

### Example 2-1 to Example 2-4

Antimicrobial coating compositions were prepared in the same manner as in Example 1-1, except that 1 wt % of each of the following UV absorbers was added instead of the antioxidant as the additive: 1,3-benzenediol, 4-[4,6-bis(2,4-dimethylphenyl)-1,3,5-triazin-2-yl] (triazine-based) (Example 2-1), benzophenone (benzophenone-based) (Example 2-2), 2-ethylhexyl 4-(dimethylamino)benzoate (Example 2-3), and 1H-benzotriazole (benzotriazole-based) (Example 2-4).

### Experimental Example 2

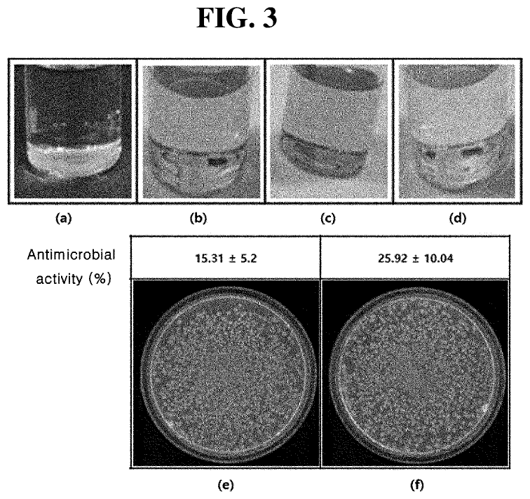

For the antimicrobial coating compositions according to Examples 2-1 to 2-4, the following items were evaluated and the results are shown in FIG. 3.

### 1. Discoloration Evaluation

The antimicrobial coating compositions according to Examples 2-1 to 2-4 were visually evaluated as to whether discoloration occurred 1 day after addition of the additive (FIGS. 3a to 3d: photographs of the compositions of Example 2-1 to Example 2-4, respectively, 1 day after addition of the additive).

As can be seen in FIG. 3, it can be confirmed that discoloration occurred in the compositions of Examples 2-1 to 2-3 according to the present inventive concept. In contrast, it can be seen that, in the composition of Example 2-4, no discoloration occurred.

### 2. Evaluation of Antimicrobial Activity

For the antimicrobial coating composition according to Example 2-4, the solvent-free antimicrobial coating composition was applied to a PET film to an average thickness of 5 μm using a bar coater, prebaked at a temperature of 75° C., and then cured with UV light, thereby preparing a film-shaped specimen. Then, the antimicrobial activity of the specimen against E. coli was measured according to the JIS Z 2801 method (FIGS. 3e and 3f: photographs of the composition not containing the additive and the composition of Example 2-4, respectively, after antimicrobial activity evaluation).

As can be seen in FIG. 3, it could be confirmed that the composition of Example 2-4 could be prevented from discoloring as described above, but the antimicrobial activity thereof was reduced.

### Example 3-1 to Example 3-3

Antimicrobial coating compositions were prepared in the same manner as in Example 1-1, except that 1 wt % of each of bis(1,2,2,6,6-pentamethyl-4-piperidyl) sebacate (Example 3-1), bis(1,2,2,6,6-tetramethyl-4-piperidyl) sebacate (Example 3-2), and dimethyl succinated polymer with 4-hydroxy-2,2,6,6-tetramethyl-1-piperidine-ethanol (Example 3-3) as a light stabilizer was added instead of the antioxidant as the additive.

### Experimental Example 3

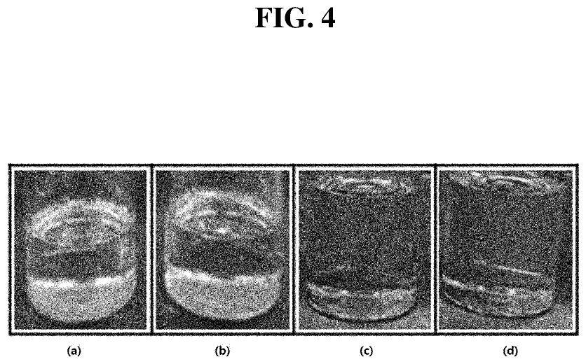

For the antimicrobial coating compositions according to Examples 3-1 to 3-3, the following items were evaluated and the results are shown in FIG. 4.

### 1. Discoloration Evaluation

The antimicrobial coating compositions according to Examples 3-1 to 3 -3 were visually evaluated as to whether discoloration occurred 4 hours after addition of the additive (FIGS. 4a to 4c: photographs of the compositions of Example 3-1 to Example 3-3, respectively, 4 hours after addition of the additive).

As can be seen in FIG. 4, it can be confirmed that discoloration occurred in the compositions of Examples 3-1 to 3 -3 according to the present inventive concept. At this time, it can be seen that, when the light stabilizer was used, discoloration occurred more quickly (4 hours).

### 2. Evaluation of Haze and Color Change

For the antimicrobial coating composition according to Example 3-1, the haze and color change were measured using a spectrophotometer according to JIS K 7105.

As a result, it was confirmed that the composition showed haze: 5.21%, a*: −0.17, b*: 1.59, and ΔE*: 1.46, indicating that the haze of the composition was excessively high.

### Example 4-1 to Example 4-4

Antimicrobial coating compositions were prepared in the same manner as in Example 1-1, except that the content of the coating material was changed to 97 wt % and a mixture of 1 wt % of an antioxidant and 1 wt % of a light stabilizer was added as an additive as follows.
Example 4-1: benzenepropanoic acid, 3,5-bis(1,1-dimethylethyl)-4-hydroxy-,C7-9 branched alkyl ester (primary phenol-based) as an antioxidant, and bis(1,2,2,6,6-pentamethyl-4-piperidyl) sebacate as a light stabilizer
Example 4-2: triethylene glycol-bis-3-(3-tert-butyl-4-hydroxy-5-methylphenyl) propionate (primary phenol-based) as an antioxidant, and bis(1,2,2,6,6-pentamethyl-4-piperidyl) sebacate as a light stabilizer
Example 4-3: isooctyl-3-(3,5-di-tert-butyl-4-hydroxyphenyl)propionate (primary phenol-based) as an antioxidant, bis(1,2,2,6,6-pentamethyl-4-piperidyl) sebacate as a light stabilizer
Example 4-4: tris(3,5-di-tert-butyl-4-hydroxybenzyl) isocyanurate (primary phenol-based) as an antioxidant, and bis(1,2,2,6,6-pentamethyl-4-piperidyl) sebacate as a light stabilizer.

### Experimental Example 4

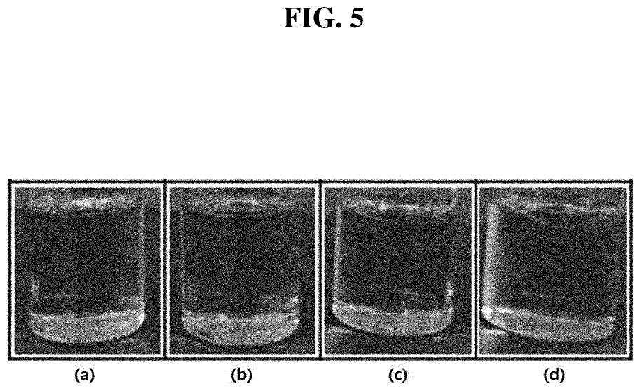

For the antimicrobial coating compositions according to Examples 4-1 to 4-4, the following items were evaluated and the results are shown in FIG. 5.

### 1. Discoloration Evaluation

The antimicrobial coating compositions according to Examples 4-1 to 4 -4 were visually evaluated as to whether discoloration occurred 1 day after addition of the additive (FIGS. 5a to 5d: photographs of the compositions of Example 4-1 to Example 4-4, respectively, 1 day after addition of the additive).

As can be seen in FIG. 5, it can be confirmed that discoloration occurred in the compositions of Examples 4-1 to 4 -4 according to the present inventive concept.

### Example 5-1 and Example 5-2

Antimicrobial coating compositions were prepared in the same manner as in Example 1-1, except that the content of the coating material was changed to 97 wt %, and a mixture of 1 wt % of an UV absorber and 1 wt % of a light stabilizer was added instead of 1 wt % of the antioxidant as the additive as follows.
Example 5-1: 1,3-benzenediol, 4-[4,6-bis(2,4-dimethylphenyl)-1,3,5-triazin-2-yl] (triazine-based) as an UV absorber, and bis(1,2,2,6,6-pentamethyl-4-piperidyl) sebacate as a light stabilizer
Example 5-2: 1,3-benzenediol, 4-[4,6-bis(2,4-dimethylphenyl)-1,3,5-triazin-2-yl] (triazine-based) as an UV absorber, and bis(1,2,2,6,6-tetramethyl-4-piperidyl) sebacate as a light stabilizer

### Experimental Example 5

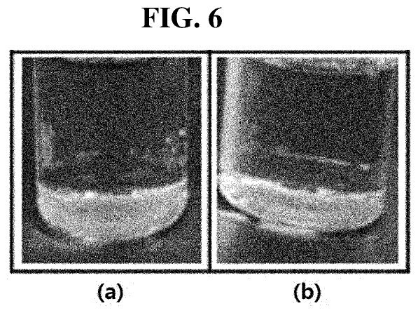

For the antimicrobial coating compositions according to Examples 5-1 and 5-2, the following items were evaluated and the results are shown in FIG. 6.

### 1. Discoloration Evaluation

The antimicrobial coating compositions according to Examples 5-1 and 5-2 were visually evaluated as to whether discoloration occurred 1 day after addition of the additive (FIGS. 6a and 6b: photographs of the compositions of Example 5-1 and Example 5-2, respectively, 1 day after addition of the additive).

As can be seen in FIG. 6, it can be confirmed that discoloration occurred in the compositions of Examples 5-1 and 5-2 according to the present inventive concept.

### Example 6-1 and Example 6-2

Antimicrobial coating compositions were prepared in the same manner as in Example 1-1, except that 1 wt % of a mixture of an UV absorber, a phenol-based antioxidant and a phosphite-based antioxidant at a weight ratio of 1:1:1 was added instead of the antioxidant as the additive as follows.
Example 6-1: N-(4-ethoxycarbonylphenyl)-N′-methyl-N′ phenylformamidine (phenylformamidine-based) as an UV absorber, benzenepropanoic acid, 3,5-bis(1,1-dimethylethyl)-4-hydroxy-,C7-9 branched alkyl ester as an antioxidant, and diisodecyl pentaerythritol diphosphate (phosphite-based) as an antioxidant
Example 6-2: 1H-benzotriazole (benzotriazole-based) as an UV absorber, benzenepropanoic acid, 3,5-bis(1,1-dimethylethyl)-4-hydroxy-,C7-9 branched alkyl ester as an antioxidant, and diisodecyl pentaerythritol diphosphate (phosphite-based) as an antioxidant

### Experimental Example 6

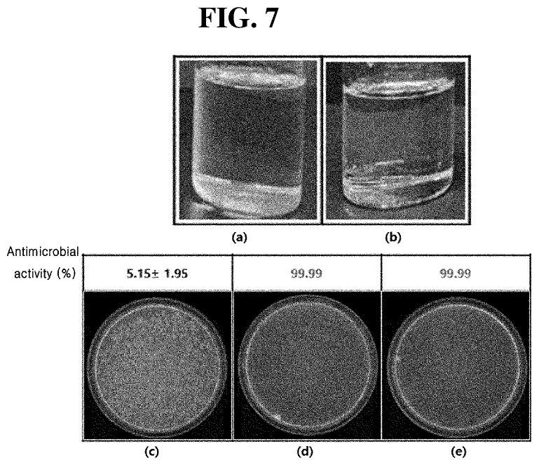

For the antimicrobial coating compositions according to Examples 6-1 and 6-2, the following items were evaluated and the results are shown in FIG. 7.

### 1. Discoloration Evaluation

The antimicrobial coating compositions according to Examples 6-1 and 6-2 were visually evaluated as to whether discoloration occurred 3 days after addition of the additive (FIGS. 7a to 7b: photographs of the compositions of Example 6-1 and Example 6-2, respectively, 3 days after addition of the additive).

As can be seen in FIG. 7, it can be found that no discoloration occurred in the compositions of Examples 6-1 and 6-2 according to the present inventive concept.

### 2. Evaluation of Antimicrobial Activity

For each of the antimicrobial coating compositions according to Examples 6-1 and 6-2, the solvent-free antimicrobial coating composition was applied to a PET film to an average thickness of 5 μm using a bar coater, prebaked at a temperature of 75° C., and then cured with UV light, thereby preparing a film-shaped specimen. Then, the antimicrobial activity of the specimen against E. coli was measured according to the JIS Z 2801 method (FIGS. 7c to 7e: photographs of the composition not containing the additive, the composition of Example 6-1, and the composition of Example 6-2, respectively, after antimicrobial activity evaluation).

As can be seen in FIG. 7, it can be confirmed that the composition of Example 6 could be prevented from discoloring as described above and also had significantly good antimicrobial activity.

### Example 7-1 to Example 7-2

Antimicrobial coating compositions were prepared in the same manner as in Example 1-1, except that 1 wt % of each of NaCO₃ (Example 7-1) and Mg(OH)₂ (Example 7-2) as a pH adjuster was added instead of the antioxidant as the additive.

### Experimental Example 7

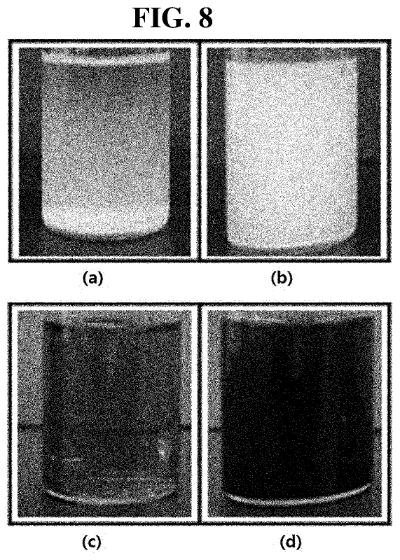

For the antimicrobial coating compositions according to Examples 7-1 and 7-2, the following items were evaluated and the results are shown in FIG. 8.

### 1. Solubility Evaluation

The antimicrobial coating compositions according to Examples 7-1 and 7-2 were evaluated for solubility, including precipitate formation, immediately after addition of the additive (FIGS. 8a and 8b: photographs of the compositions of Examples 7-1 and 7-2, respectively, immediately after addition of the additive).

As can be seen in FIG. 8, it can be found that, in the compositions of Examples 7-1 and 7-2 according to the present inventive concept, a reaction occurred immediately after mixing to form a precipitate.

### 2. Discoloration Evaluation

The antimicrobial coating compositions according to Examples 7-1 and 7-2 were visually evaluated as to whether discoloration occurred 1 day after addition of the additive (FIGS. 8c and 8d: photographs of the compositions of Examples 7-1 and 7-2, respectively, 1 day after addition of the additive).

As can be seen in FIG. 8, it can be found that discoloration occurred in the compositions of Examples 7-1 and 7-2 according to the present inventive concept.

### Example 8-1 to Example 8-5

Antimicrobial coating compositions were prepared in the same manner as in Example 1-1, except that 1 wt % of each of Ba stearate (Example 8-1), Zn stearate (Example 8-2), Mg stearate (Example 8-3), K stearate (Example 8-4), and Ca stearate (Examples 8-5), which are stearate-based materials known to be effective against silver discoloration, was added instead of the antioxidant as the additive.

### Experimental Example 8

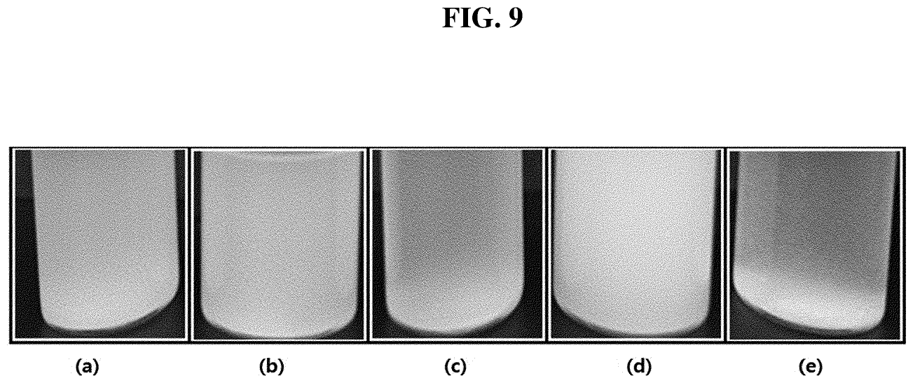

For the antimicrobial coating compositions according to Examples 8-1 to 8-5, the following items were evaluated and the results are shown in FIG. 9.

### 1. Solubility Evaluation

The antimicrobial coating compositions according to Examples 8-1 to 8-5 were evaluated for solubility, including precipitate formation, immediately after addition of the additive (FIGS. 9a to 9e: photographs of the compositions of Examples 8-1 to 8-5, respectively, immediately after addition of the additive).

As can be seen in FIG. 9, it can be confirmed that, in the compositions of Examples 8-1 to 8-5 according to the present inventive concept, the components did not dissolve or disperse and formed a precipitate, after mixing.

### Example 9-1 and Example 9-2

Antimicrobial coating compositions were prepared in the same manner as in Example 1-1, except that each of an UV absorber and an antioxidant was added instead of the antioxidant as the additive.
Example 9-1: N-(4-ethoxycarbonylphenyl)-N′-methyl-N′ phenylformamidine (phenylformamidine-based) as an UV absorber
Example 9-2: diisodecyl pentaerythritol diphosphate (phosphite-based) as an oxidant

### Experimental Example 9

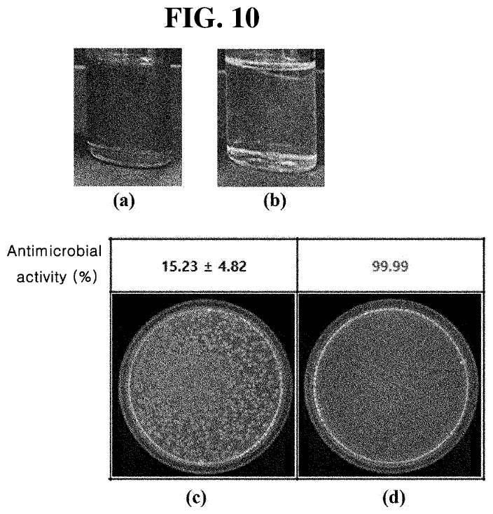

For the antimicrobial coating compositions according to Examples 9-1 and 9-2, the following items were evaluated and the results are shown in FIG. 10.

### 1. Discoloration Evaluation

The antimicrobial coating compositions according to Examples 9-1 and 9-2 were visually evaluated as to whether discoloration occurred 3 days after addition of the additive (FIGS. 10a and 10b: photographs of the compositions of Examples 10-1 and 10-2, respectively, 1 day after addition of the additive).

As can be seen in FIG. 10, it can be confirmed that discoloration occurred in the composition of Example 9-1 according to the present inventive concept, but discoloration did not occur in the composition of Example 9-2.

### 2. Evaluation of Antimicrobial Activity

For the antimicrobial coating composition according to Example 9-2, the solvent-free antimicrobial coating composition was applied to a PET film to an average thickness of 5 μm using a bar coater, prebaked at a temperature of 75° C., and then cured with UV light, thereby preparing a film-shaped specimen. Then, the antimicrobial activity of the specimen against E. coli was measured according to the JIS Z 2801 method (FIGS. 10c and 10d: photographs of the composition not containing the additive and the composition of Example 9-2, respectively, after antimicrobial activity evaluation).

As can be seen in FIG. 10, it can be confirmed that the composition of Example 9-2 could be prevented from discoloring described above and also has significantly good antimicrobial activity.

### 2. Evaluation of Haze and Color Change

For the antimicrobial coating composition according to Example 9-2, the haze and color change were measured using a spectrophotometer according to JIS K 7105.

As a result, it was confirmed that the composition showed haze: 0.28%, a*: −0.11, b*: 0.46, and ΔE*: 2.92, indicating that the haze of the composition was significantly low and the color change of the composition was also significantly low.

Although the embodiments of the present inventive concept have been described above, the spirit of the present inventive concept is not limited to the embodiments presented in the present specification. Those skilled in the art who understand the spirit of the present inventive concept may easily suggest other embodiments by adding, changing, or deleting components within the scope of the same concept, and the other embodiments are also within the spirit of the present inventive concept.

1. An antimicrobial coating composition comprising:
an antimicrobial agent containing silver;
a coating material containing a viscosity modifier; and
an additive.

2. The antimicrobial coating composition according to claim 1, wherein the antimicrobial agent comprises a solvent and a silver salt.

3. The antimicrobial coating composition according to claim 1, wherein the coating material comprises a hexafunctional urethane acrylate-based oligomer.

4. The antimicrobial coating composition according to claim 1, wherein the viscosity modifier is at least one selected from the group consisting of 1,6-hexanediol diacrylate (HDDA), dipropylene glycol diacrylate (DPGDA), dipentaerythritol pentaacrylate (DPPA), dipentaerythritol hexaacrylate (DPHA), isobornyl acrylate (IBOA), tripropylene glycol diacrylate (TPGDA), pentaerythritol triacrylate (PETA), pentaerythritol tetraacrylate (PETTA), and trimethylolpropane triacrylate (TMPTA).

5. The antimicrobial coating composition according to claim 1, wherein the additive comprises any one or more selected from the group consisting of an antioxidant, an UV absorber, a light stabilizer, and a pH adjuster.

6. The antimicrobial coating composition according to claim 1, wherein the additive is at least one of a phenylformamidine-based UV absorber, a phenol-based antioxidant, and a phosphite-based antioxidant.

7. The antimicrobial coating composition according to claim 1, wherein the antimicrobial agent, the coating material and the additive are comprised in amounts of 0.5 to 1.5 wt %, 97 to 99 wt %, and 0.5 to 1.5 wt %, respectively.

8. The antimicrobial coating composition according to claim 1, which has an antimicrobial activity of 99.9% or more as evaluated according to the following Experimental Method 1:
[Experimental Method 1]
Apply the antimicrobial coating composition to a PET film to an average thickness of 5 μm using a bar coater, prebake the applied composition at a temperature of 75°C, cure the prebaked composition with UV light to obtain a film-shaped specimen, and then measure the antimicrobial activity of the specimen against E. coli according to JIS Z 2801 method.

9. The antimicrobial coating composition according to claim 1, which has a haze of 3% or less and a color change (ΔE*) of 5 or less, as evaluated according to the following Experimental Method 2:
[Experimental Method 2]
Measure the haze and color change of the antimicrobial coating composition using a spectrophotometer according to JIS K 7105.

10. A method for producing an antimicrobial product comprising:
a first step of preparing an antimicrobial agent by adding an antimicrobial agent containing silver to a solvent;
a second step of preparing an antimicrobial coating composition by mixing the antimicrobial agent with a coating material, which contains a viscosity modifier, and an additive; and
a third step of coating a product with the antimicrobial coating composition.
